(19) United States
(12) Patent Application Publication
(10) Pub. No.: US 2018/0265023 A1
(43) Pub. Date: Sep. 20, 2018

(54) ADDITIVELY MANUFACTURED LATTICE CORE FOR ENERGY ABSORBERS ADAPTABLE TO DIFFERENT IMPACT LOAD CASES

(71) Applicant: FORD GLOBAL TECHNOLOGIES, LLC., Dearborn, MI (US)

(72) Inventors: Mohammed Omar FARUQUE, Ann Arbor, MI (US); James Chih CHENG, Troy, MI (US); Ching-Hung CHUANG, Northville, MI (US)

(21) Appl. No.: 15/463,640

(22) Filed: Mar. 20, 2017

(51) Int. Cl. B60R 19/18; B33Y 80/00; B33Y 10/00; B29C 47/00

(52) U.S. Cl. CPC B60R 19/18; B33Y 80/00; B29L 2031/721; B29C 47/0064; B33Y 10/00

(57) ABSTRACT

An energy absorber including a cover defining a cavity and a lattice core. The lattice core includes rod-shaped links having first and second ends connected at spaced nodes to form a three-dimensional structure disposed inside the cavity. The lattice core includes a first portion and a second portion that has a higher density than the first portion. The second portion is arranged behind the first portion relative to an expected direction of an impact with an object that initially contacts the cover in front of the first portion. A third portion may be arranged behind the second portion relative to the expected direction of an impact that has a higher density than the second portion. The first core may be a three-dimensional body having a negative Poisson's Ratio. The lattice core may be formed by an additive printing process.

### TECHNICAL FIELD

This disclosure relates to energy absorbing structures and methods of making structures that are adaptable to meet collision test requirements with different size targets having different masses at different speeds.

### BACKGROUND

Passive energy absorbers are utilized in a wide variety of application on a vehicle to absorb the impact energy from a collision and manage crash energy and the resultant deformation of the vehicle. An energy absorber may be included as part of a bumper assembly, a door beam, an interior bolster, an arm rest, or the like. A bumper assembly is one example of an energy absorber that is subject to many tests.

One example of a test of a bumper assembly is the low velocity bumper impact test in which an impactor that is between 0.4-0.6 meters wide and having a mass equal the vehicle curb weight and with a speed of the impact of 4 kph. The purpose of this test is to minimize axial deformation and thereby minimize damage to the bumper and other structures rear of the bumper.

Another example of a test of a bumper assembly is an RCAR association test that measures the damage to a vehicle in which an impactor has a width equal to about 40% of the width of the bumper and having a mass equal the vehicle curb weight and with a speed of the impact of 15 kph. The purpose of this test is to limit axial deformation so that it is contained within the energy absorber to minimize vehicle front end damage.

Another example of a test of a bumper assembly is a pedestrian leg impact test that measures the extent of cushioning provided for an impact with a pedestrian's leg. The extent of cushioning is measured in an impact with a pedestrian leg impactor having a width of 75-90 mm at the widest point and having a mass of about 13.8 kg and with a speed of the impact of 40 kph. The purpose of the test is to test the ability of the energy absorber to minimize leg injuries by reducing the impact force through a greater degree of deformation.

Conventional energy absorbers may fail some of the above tests but pass the other tests because the required stiffness to pass some tests necessitates failure in the other tests that require compliance.

This disclosure is directed to solving the above problems and other problems as summarized below.

### SUMMARY

According to one aspect of this disclosure, an energy absorber is disclosed that includes a cover defining a cavity and a lattice core. The lattice core includes rod-shaped links having first and second ends connected at spaced nodes to form a three dimensional structure disposed inside the cavity. The lattice core includes a first portion and a second portion that has a higher density than the first portion. The second portion is arranged behind the first portion relative to an expected direction of an impact with an object that initially contacts the cover in front of the first portion.

According to other aspects of this disclosure, a third portion may be arranged behind the second portion relative to the expected direction of an impact that has a higher density than the second portion. The rod-shaped links may include long links in the first portion and intermediate length links in the second portion that are shorter than the long links. The short links in the third portion are shorter than the intermediate links. Alternatively, the first portion may include long links and the second portion may include short links that are shorter than the long links.

The links in the first portion are arranged in a pattern defining large triangular spaces and the links in the second portion are arranged in a pattern defining small triangular spaces that are smaller than the large triangular spaces.

The density of the lattice core may be controlled by varying one or more of yield strength, ductility, modulus of elasticity and ultimate strength of a plurality of links interconnected to form the lattice core.

According to another aspect of this disclosure, an energy absorber is disclosed that includes an enclosure and first and second cores. The first core is formed of rod-shaped links connected at spaced nodes forming a first three-dimensional body having a negative Poisson's Ratio. The second core is of rod-shaped links having first and second ends connected at spaced nodes forming a second three-dimensional body having a positive Poisson's Ratio. The second core is disposed inside the enclosure behind the first core relative to an expected direction of an impact with an object.

The first core in an area behind where the first core is impacted by the object has an initial density that changes to a post-impact density that is greater than the initial density.

The first core may include a first layer formed of the rod-shaped links and a second layer formed of a second set of rod-shaped links that has a greater initial density than the first layer.

According to another aspect of this disclosure, a method is disclosed for manufacturing an energy absorber. The method includes the steps of printing a first lattice core having a plurality of links connected at spaced nodes to form a three-dimensional body having a negative Poisson's Ratio. A second lattice core is printer that has a second plurality of links connected at spaced nodes to form a three-dimensional body having a positive Poisson's Ratio. The first and second lattice cores are solidified and are then assembled inside an enclosure or cover.

The second lattice core may be arranged behind the first lattice core relative to an expected direction of an impact with an object that initially contacts cover over the second lattice core. During the printing steps a plurality of links may be formed with a plurality of nodes connecting the links to different ones of the links that are connected to form the first and second lattice cores. The links have a first end and a second end connected by the spaced nodes to the first end or the second end of a different link.

In the printing steps, a first set of links may be formed by printing a first material, and a second set of links may be formed by a printing a second material that has different material properties than the first material.

The step of assembling the first and second lattice cores inside the enclosure may further comprise forming the first and second lattice cores in a plurality of segments that are separately assembled into the enclosure.

The enclosure may be a container formed by a process of extruding the container, wrapping a sheet of material around the first and second lattice cores, injection molding the container, or assembling a plurality of panels.

The above aspects of this disclosure and other aspects will be described below with reference to the attached drawings.

### BRIEF DESCRIPTION OF THE DRAWINGS

FIG. 1 is a front/left perspective view of a vehicle in phantom with an energy absorber made according to one aspect of this disclosure.

FIG. 2 is a diagrammatic perspective view of one embodiment of an energy absorber attached to a bumper.

FIG. 3 is a fragmentary diagrammatic perspective view of the energy absorber of FIG. 2 showing a plurality of layers of rod-shaped links forming lattice structures that are disposed in a container.

FIG. 4 is a diagrammatic perspective view of the energy absorber showing the plurality of layers of rod-shaped links forming lattice structures with the container removed.

FIG. 5 is a diagrammatic side elevation view of the energy absorber showing a plurality of layers of rod-shaped links forming a lattice structure having layers with two different levels of density.

FIG. 6 is a diagrammatic side elevation view of the energy absorber showing a plurality of layers of rod-shaped links forming a lattice structure having layers with three different levels of density.

FIG. 7 is a perspective view of a module of a lattice core made up of a plurality of links connected at spaced nodes to form a three-dimensional structure having a negative Poisson's Ratio.

FIG. 8 is a side elevation view of a module of a lattice core made up of a plurality of links connected at spaced nodes to form a three-dimensional structure having a negative Poisson's Ratio.

FIG. 9 is a diagrammatic side elevation view of a plurality of links connected at spaced nodes to form a three-dimensional structure having a negative Poisson's Ratio.

FIG. 10 is a diagrammatic perspective view of two of the structures shown in FIG. 9 stacked up in a row.

FIGS. 11 A-C are a series of diagrammatic views showing a progression of an impact with a three-dimensional structure having a negative Poisson's Ratio.

FIG. 12 is a graph showing a simulated pedestrian test of an energy absorber of FIGS. 2-5 that was the subject of the test of FIG. 11 tested with a narrow, low mass impactor in a high velocity impact.

FIG. 13 is a graph showing a simulated test of an energy absorber of FIGS. 2-5 that was the subject of the test of FIG. 12 with a wide, high mass impactor in a low velocity impact.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

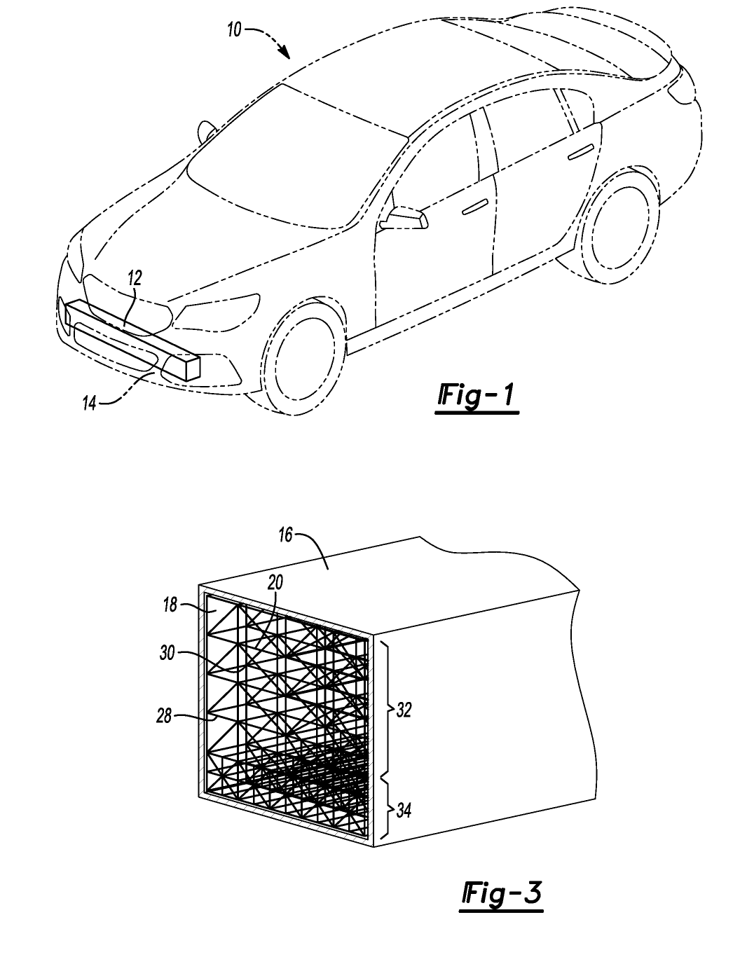

Referring to FIG. 1, a vehicle shown in phantom lines is generally indicated by reference numeral 10. An energy absorber 12 is shown assembled to the front end of the vehicle 10 behind a front fascia 14.

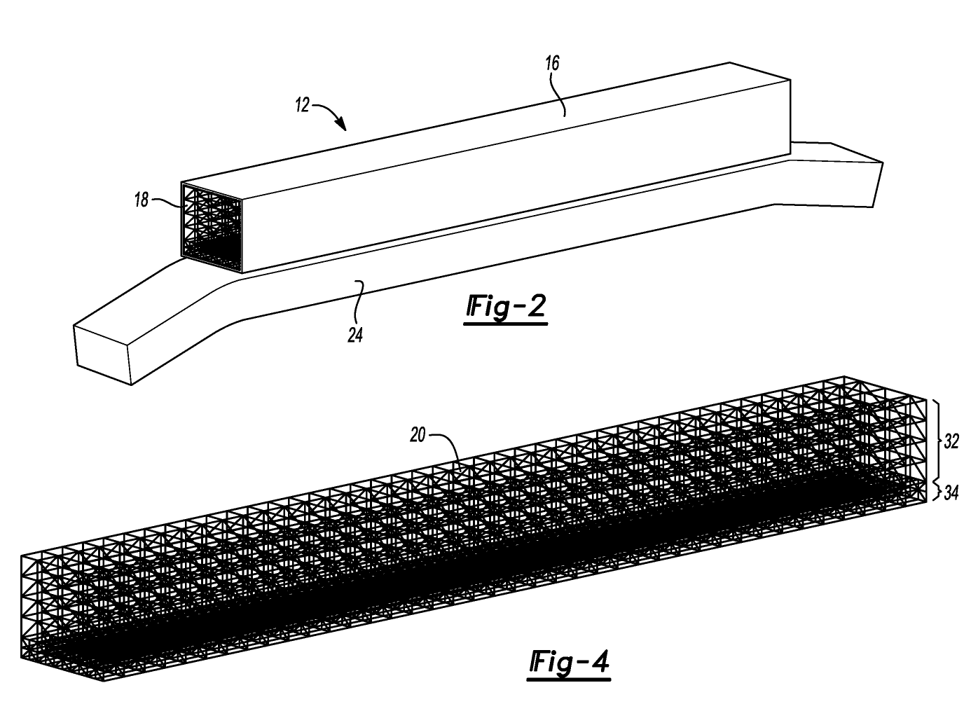

Referring to FIG. 2, The energy absorber 12 is shown to include a cover 16, or enclosure, that may be made as an extrusion, by wrapping a sheet, injection molding or assembling together a plurality of walls or sides. The enclosure 16 defines a cavity 18 that is adapted to receive a lattice core 20. The structure of the lattice core 20 will be described in detail below with reference to FIGS. 3-5. The energy absorber in FIG. 2 is shown attached to the front surface of a bumper beam 24.

Referring to FIGS. 3-5, a fragment of the energy absorber 12 is illustrated in a magnified view. The energy absorber 12 includes the cover 16 that defines the cavity 18. The lattice core 20 is disposed within the cavity 18. The lattice core 20 is made up of a plurality of rod-shaped links 28 that may have different lengths. The rod-shaped links 28 may be long, short or of intermediate length. The rod-shaped links 28 are connected on their ends at nodes 30. The lattice core 20 includes a first portion 32, or first core, and a second portion 34, or second core. The first portion 32 is less dense than the second portion 34 and is positioned in front of the second portion. The front as referred to herein is the part of the lattice core 20 that is oriented to be contacted through the cover first in a collision from an expected direction of the impact with an object.

Referring to FIG. 4. The lattice core 20 is illustrated in isolation without the cover. The first portion 32 of the lattice core 20 is shown disposed above the second portion 34 of the lattice core 20. If the lattice core illustrated in FIG. 4 were attached to a bumper the second portion would be attached to the front of the bumper and the first portion would face the front or expected direction of the impact with an object.

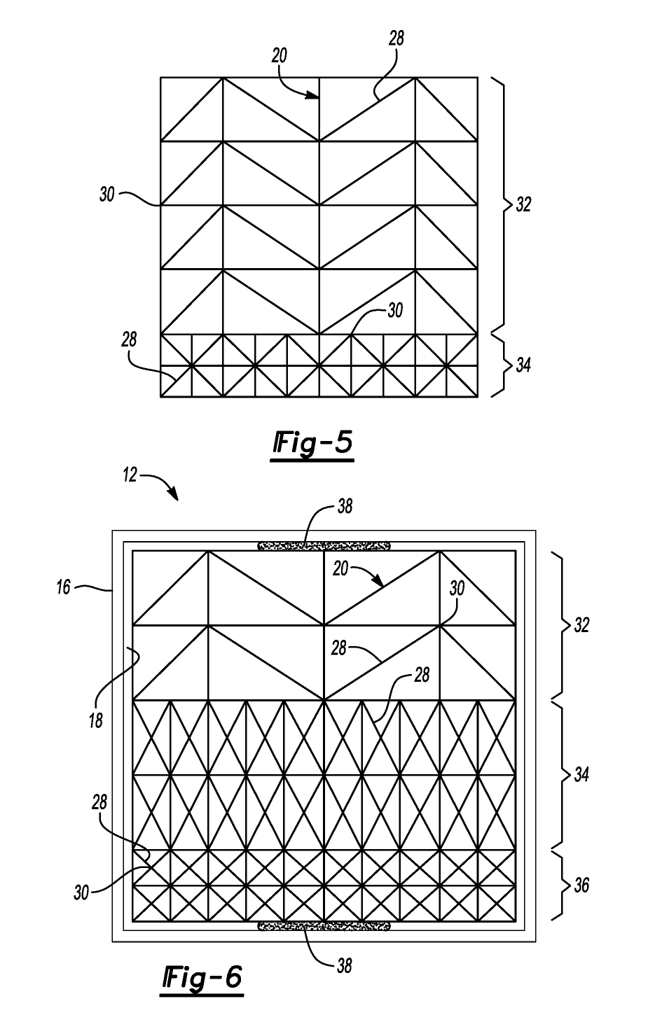

Referring to FIG. 5, the lattice core 20 is diagrammatically illustrated and includes four layers that make up the first core 32 and one layer that makes up the second core 34. The second core 34 is denser than the first core 32 and has rod-shaped links 28 that are shorter than the rod-shaped links 28 in the first core 32. The shorter links 28 define smaller triangular openings in the first core 32 than are defined in the second core 34.

Referring to FIG. 6, another embodiment of an energy absorbing assembly 12 is shown to include a cover 16 that defines a cavity 18 for receiving a lattice core 20. The lattice core 20 is made up of a plurality of different lengths of rod-shaped links 28 that provide different density or resistance to impact or energy absorbing ability. The rod-shaped links 28 are connected at nodes 30 that are provided at the ends of the rod-shaped links 28. A first portion of the lattice core 20, or first core, is indicated by reference numeral 32. A second portion of the lattice core 20, or second core, is identified by reference numeral 34. A third portion 36 of the lattice core 20 is provided and may also be referred to as a third core 36.

In the embodiment of FIG. 6, the upper portion of the figure is the surface of the energy absorber assembly 12 oriented to initially receive an impact. The second portion 34 of the lattice core that has a higher density than the first portion 32. The second portion 34 is arranged behind the first portion 32 relative to an expected direction of an impact with an object that initial contacts the cover 16. The third portion is arranged behind the second portion relative to the expected direction of an impact and has a higher density than the second portion 34.

The lattice core 20 is a 3-D printed core. The lattice core 20 may be printed as a unitary structure with the three portion being sequentially printed to provide a single lattice structure having three different densities. Alternatively, the lattice core may be developed by 3-D printing and then used to form a mold. The mold may be a unitary mold including all three portions. Alternatively, the lattice core 20 may be injection molded in three separate layers that are then assembled into the cover 16.

The lattice core 20 may be secured to the cover 16 by patches of adhesive 38 that are either applied to outer-most rod-shaped links 28 or the inner surface of the cover 16. The adhesive 38 is used to secure the lattice core 20 within the cover 16 so that is does not move or shift within the enclosure 16.

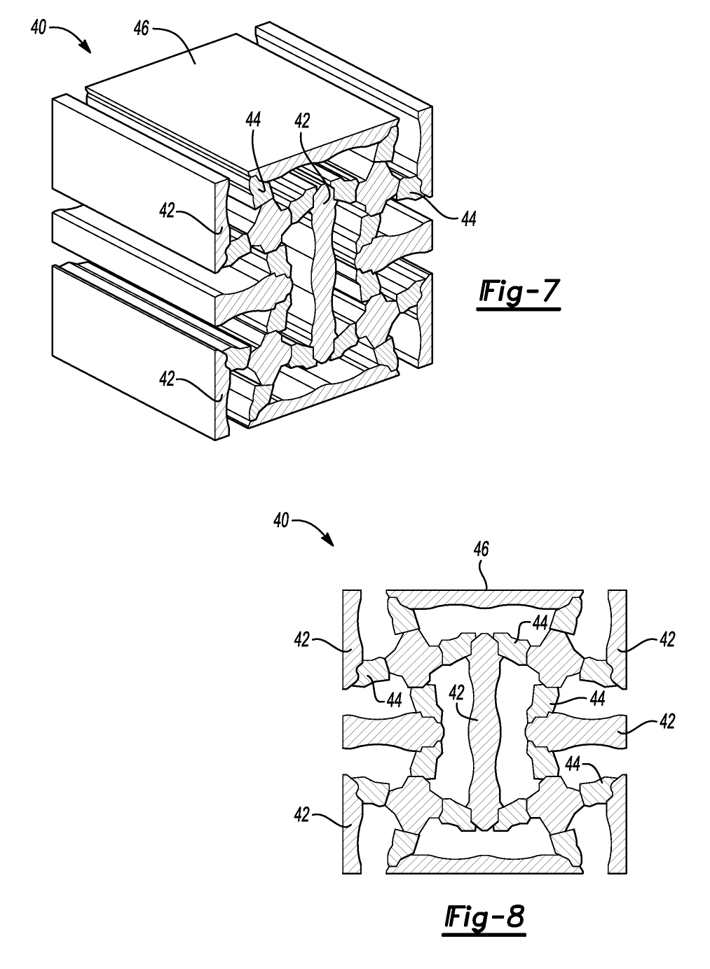

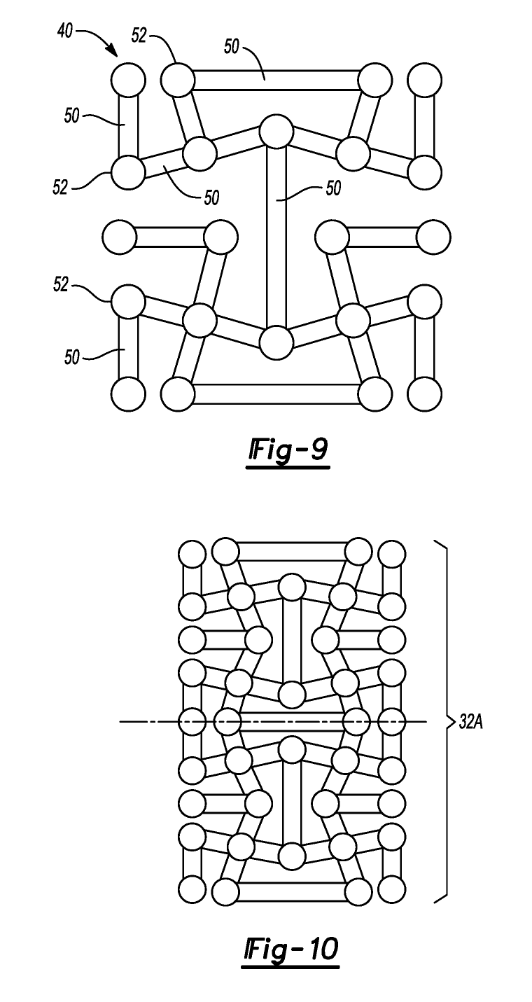

Referring to FIGS. 7 and 8, a lattice core 40 having a negative Poisson Ratio as illustrated that is made up of 3-D printed links. A first set of links 42 may be made of one material in a 3-D printing operation and the second set of links 44 may be made up of a different material. The links are connected at nodes 30 that correspond to the interface between the first and second set of links 42 and 44. The lattice core 40 may also be referred to as an auxetic lattice core 40. The lattice core 40 having a negative Poisson Ratio is developed in the 3-D printing process so that in response to an impact force being applied to the upper most link 46, the core contracts, or is consolidated, as a result of the pivoting movement of the first and second sets of links 42 and 44. Auxetic structures are structures that have a negative Poisson Ratio and will expand when stretched and conversely contract when compressed by an impact force applied to the structure.

Referring to FIGS. 9 and 10, an auxetic lattice core 40 is diagrammatically shown that includes links 50 that are made of the same material and are connected at nodes 52. The lattice core 40 is constructed to have a negative Poisson Ratio as described above with reference to FIGS. 7 and 8.

Referring to FIG. 10, an auxetic core having two layers is illustrated with the layers being separated as indicated by the dashed line. The auxetic core shown in FIG. 10 may be combined in the assembly previously described with reference to FIG. 6 with the first portion referred to as 32A in FIG. 10 being substituted for the first portion of the core 32 shown in FIG. 6. In this way, a lattice core having an auxetic portion of reduced density compared to one or more layers of lattice core having a positive Poisson Ratio may be provided as indicated in FIG. 6. The two layers that have a positive Poisson Ratio are referred to as layers 34 and 36 in FIG. 6. The layers 34 and 36 having a positive Poisson Ratio may be 3-D printed in the same 3-D printing operation as the layer 32A that has a negative Poisson Ratio. The ability to 3-D print the lattice core offers substantial additional flexibility in designing energy absorbers to meet a wide variety of collisions. Collisions with barriers or pedestrian leg have different requirements resulting from differences in the area impacted and the speed of impact with the barrier or object. By providing the ability to 3-D print auxetic, non-auxetic and combination auxetic, non-auxetic lattice cores offer the designer a great deal of flexibility in designing energy absorbers.

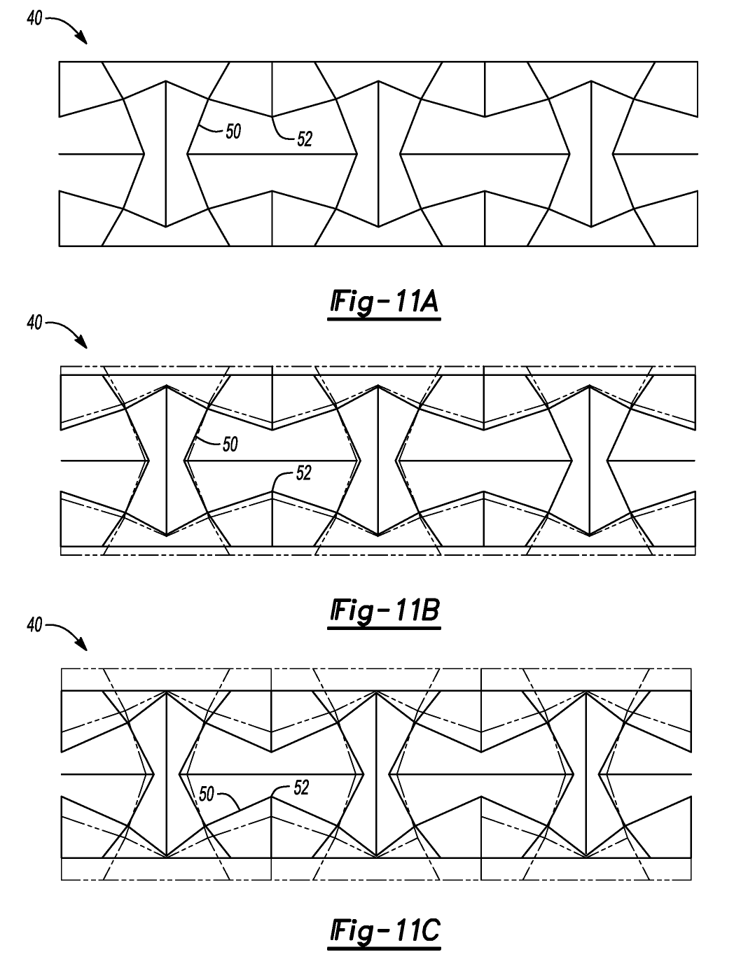

Referring to FIGS. 11A-11C, a progression of impacts with an auxetic core 40 is diagrammatically illustrated. In FIG. 11A, the auxetic core 40 is shown in its initial configuration. In FIG. 11B, the auxetic core is shown with incremental deformation and in FIG. 11C the auxetic core 40 is shown with increased deformation compared to FIG. 11B. In FIGS. 11A-C, a plurality of links that are connected nodes 52 are shown as they are subjected to a compressive force received from the direction at the top of each of the figures. In the initial incremental deformation shown in FIG. 11C, the lattice core 40 is more fully compressed than in FIG. 11B as a result of absorbing the impact of a collision. As shown in FIG. 11C, the extent of compression is increased and the links are compressed as the nodes bend in response to the impact force.

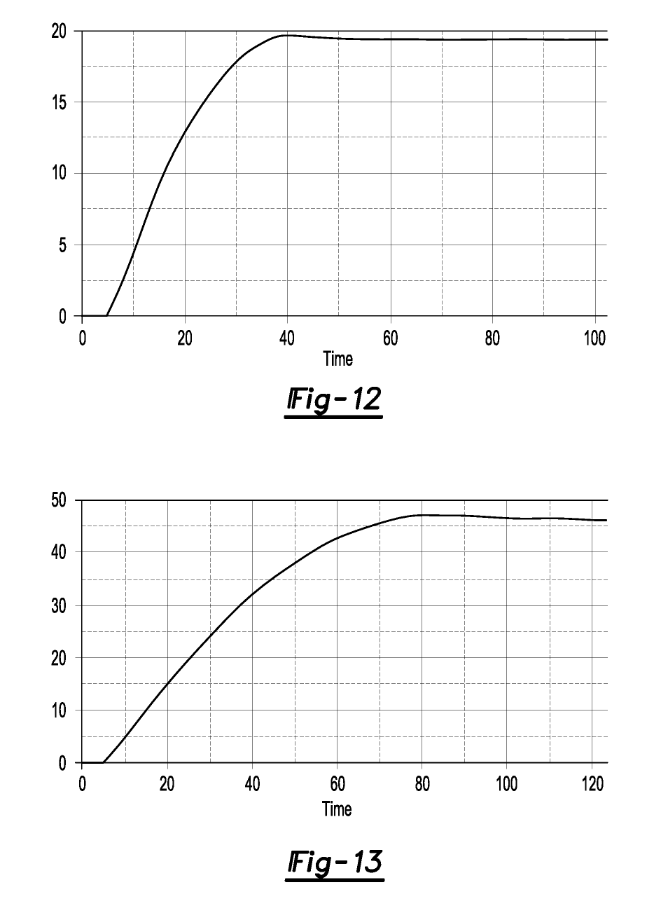

Referring to FIGS. 12 and 13, are Computer Aided Engineering (CAE) graphs showing the results of simulated tests of the energy absorber 12 being contacted by a wide impactor or barrier and a narrow impactor. The computer-aided engineering simulations are provided for impactors with the same mass but at different velocities.

In FIG. 12, the wide impactor is approximately 16 inches in width to resemble a low speed impact at 4 kph with a bumper. The maximum deformation in this case is limited to about 20 millimeters.

Referring to FIG. 13, a narrow, pedestrian leg type impact is analyzed for an impact velocity of approximately 15 kph. In this case, the maximum deformation is approximately 45 millimeters. The deformation in test shown in FIG. 13 is significantly higher than the low speed impact with a wider barrier and provides better cushioning for the pedestrian leg as simulated.

The CAE results provided in FIGS. 12 and 13 is intended to illustrate the proof of the concept of providing the lattice core energy absorber within a cover or enclosure and the number of layers, density of layers, materials used and other perimeters may be optimized to develop an energy absorber that meets any one of a number of different impact absorbing requirements.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. An energy absorber comprising:
a cover defining a cavity; and
a lattice core including rod-shaped links having first and second ends connected at spaced nodes to form a three dimensional structure disposed inside the cavity, the lattice core including a first portion and a second portion that has a higher density than the first portion arranged behind the first portion relative to an expected direction of an impact with an object that initially contacts cover.

2. The energy absorber of claim 1 further comprising:
a third portion arranged behind the second portion relative to the expected direction of an impact that has a higher density than the second portion.

3. The energy absorber of claim 2 wherein the rod-shaped links include long links in the first portion and intermediate links in the second portion that are shorter than the long links and short links in the third portion that are shorter than the intermediate links.

4. The energy absorber of claim 1 wherein the first portion includes long links and the second portion includes short links that are shorter than the long links.

5. The energy absorber of claim 1 wherein the links in the first portion are arranged in a pattern defining large triangular spaces and the links in the second portion are arranged in a pattern defining small triangular spaces that are smaller than the large triangular spaces.

6. The energy absorber of claim 1 wherein density of the lattice core is controlled by varying one or more of yield strength, ductility, modulus of elasticity and ultimate strength of a plurality of links interconnected to form the lattice core.

7. An energy absorber comprising:
an enclosure;
a first core formed of rod-shaped links connected at spaced nodes forming a first three-dimensional body having a negative Poisson's Ratio; and
a second core of rod-shaped links having first and second ends connected at spaced nodes forming a second three-dimensional body having a positive Poisson's Ratio and being disposed inside the enclosure behind the first core relative to an expected direction of an impact with an object.

8. The energy absorber of claim 7 wherein the first core has an initial density that changes to a post-impact density that is greater than the initial density in an area behind where the first core is impacted by the object.

9. The energy absorber of claim 7 wherein the first core includes a first layer formed of the rod-shaped links and a second layer formed of a second set of rod-shaped links that has a greater initial density than the first layer.

10. A method of manufacturing an energy absorber comprising:
printing a first lattice core having a plurality of links connected at spaced nodes to form a three-dimensional body having a negative Poisson's Ratio;
printing a second lattice core having a second plurality of links connected at spaced nodes to form a three-dimensional body having a positive Poisson's Ratio;
solidifying the first and second lattice cores; and
assembling the first and second lattice cores within an enclosure.

11. The method of claim 10 wherein the second lattice core is arranged behind the first lattice core relative to an expected direction of an impact with an object that initially contacts cover over the second lattice core.

12. The method of claim 10 wherein during the printing steps a plurality of links are formed with a plurality of nodes connecting the links to different ones of the links that are connected to form the first and second lattice cores, wherein the links each have a first end and a second end connected by the spaced nodes to the first end or the second end of a different link.

13. The method of claim 12 the links are formed by printing, wherein a first set of links is formed by printing a first material, and a second set of links is formed by a printing a second material that has different material properties than the first material.

14. The method of claim 10 wherein the step of assembling the first and second lattice cores inside the enclosure further comprises:
forming the first and second lattice cores in a plurality of segments that are separately assembled into the enclosure.

15. The method of claim 10 wherein the enclosure is a container formed by a process selected from the group consisting of:
extruding the container;
wrapping a sheet of material around the first and second lattice cores;
injection molding the container; and
assembling a plurality of side panels of the container.
